(19) United States
(12) Patent Application Publication
(10) Pub. No.: US 2025/0050614 A1
(43) Pub. Date: Feb. 13, 2025

(54) FIRE PROTECTION LAYER COMPOSITE FOR USE AS PREVENTIVE FIRE PROTECTION MATERIAL

(71) Applicants: Gerhard MEYER, Wesel (DE); FRAUNHOFER-GESELLSCHAFT ZUR FÖRDERUNG DER ANGEWANDTEN FORSCHUNG E.V., München (DE)

(72) Inventors: Gerhard MEYER, Wesel (DE); Thomas HOYER, Hermsdorf (DE); Annett GÜNTHER, Hermsdorf (DE)

(21) Appl. No.: 18/722,408

(22) PCT Filed: Dec. 16, 2022
(86) PCT No.: PCT/EP2022/086450

§ 371 Date: Jun. 20, 2024

(30) Foreign Application Priority Data
Dec. 22, 2021 (DE) 10 2021 134 311.9

(51) Int. Cl. B32B 3/04; B32B 5/18; B32B 9/04; B32B 13/02; B32B 13/12; B32B 17/10; B32B 27/06; B32B 27/18; B32B 37/18

(52) U.S. Cl. CPC B32B 3/04; B32B 5/18; B32B 9/045; B32B 13/02; B32B 13/12; B32B 17/10036; B32B 17/10311; B32B 17/10761; B32B 17/10788; B32B 27/065; B32B 27/18; B32B 37/182; B32B 2264/1021; B32B 2264/301; B32B 2307/3065; B32B 2307/412; B32B 2307/7376; B32B 2309/02

(57) ABSTRACT

Disclosed is a fire protection layer composite for use as preventive fire protection material, and to a method for producing a fire protection layer composite. The invention relates to non-flammable and fire-retardant materials, in particular film composites which are intumescent in the event of a fire. The fire protection layer composite comprises at least one plastics layer, which surrounds a transparent fire protection layer, wherein the fire protection layer comprises an intumescent material. The fire protection layer composite makes it possible to achieve effective fire protection in a compact design. The fire protection layer composite does not produce soot or release toxic flue gases, even under the influence of very high temperatures. This prevents danger to the health of a user of the fire protection layer composite in the event of a fire.

The invention comprises a fire protection layer composite for use as a preventive fire protection material, and a method for producing a fire protection layer composite according to the respective independent claims. The invention relates to the technical field of non-combustible and fire-retardant materials, in particular film composites that are intumescent in the event of fire. The fire protection layer composite provided comprises at least one plastic layer, which surrounds a transparent fire protection layer, wherein the fire protection layer comprises an intumescent material. The fire protection layer composite makes it possible to achieve effective fire protection in a compact design. In addition, the fire protection layer composite can be characterized in that it does not release any soot or toxic smoke gases even when exposed to very high temperatures. In this way it is possible to prevent a user of the fire protection layer composite from being exposed to health hazards in the event of a fire.

Preferably, non-combustible materials are used in many sectors of industry, transport or in residential areas etc. If combustible materials have to/should be used, they still need to be flame-retardant. Otherwise ignition has to be prevented. The group of organic polymers or plastics is an important group of materials with very diverse areas of application which are always combustible due their chemical basis—these consist mainly of organic hydrocarbons in combination with heteroatoms including nitrogen or oxygen etc.—and usually represent a high fire load in the event of fire and cause the propagation of fire.

To avoid this problem, the combustible substances have so far been replaced by a non-combustible substance, but this leads to a limited choice of materials.

Another away to solve the problem is to add expanded graphite or aluminum hydroxide as powder fillers or phosphonates to polymers for example. When exposed to heat, the expandable graphite expands and forms an intumescent layer on the surface of the material. This slows down the spread of fire and counteracts the most dangerous consequences of fire for humans, namely the formation of toxic gases and smoke. This can reduce the flammability if necessary. However, this often also seriously changes the polymer properties. For the production of transparent, organic polymer films, phosphonates are then almost the only remaining option. However, their flame-retardant effect is often below average.

In fire protection, the term “intumescent” refers to the expedient “swelling” or foaming of materials from the effect of heat.

Intumescent building materials increase in volume and decrease in density accordingly when exposed to heat. As a rule, intumescent materials are used in preventative structural fire protection, where they can fulfill the following tasks:
foaming to form a light insulating layer as a heat barrier. Expandable graphite releases gases when exposed to heat. If, for example, it is added to the insulating sheath of an electric cable, it forms a “foamed” ash layer with the incinerating insulation material, which impedes the supply of oxygen and therefore the spread of flames.
Endothermic cooling by evaporating crystal water (hydrates); e.g., with building materials made of gypsum.
Formation of a fire protection limit by expansion pressure, e.g., when filling the cavity which is left by a melting plastic pipe in a wall or ceiling opening.

Intumescent building materials are also known as “intumescent formers”.

There is also the option of cladding or coating. There are for example white polymer films, highly filled with aluminum hydroxide, which are highly flame-retardant and form an effective barrier against flames, e.g., on wooden surfaces. However, these films are not suitable for all applications due to their color.

Known materials are for example flexible films, fabrics and non-wovens which are fire-retardant but do not have a significant batter effect in the event of a fire. Some of the known materials are transparent products.

On the other hand, flexible films, fabrics and non-wovens with a fire-retardant are known which have a barrier effect in the event of fire. However, these are not transparent and are therefore not suitable for every application, e.g., in the area of surfaces.

Furthermore, there are already coatings with a fire-retardant effect which develop a barrier effect in the event of a fire and can be applied to a surface as a transparent varnish, for example. The disadvantage here is that such coatings are not sufficiently durable and resistant.

Therefore, the objective of the invention is to provide a fire protection layer composite for use as a preventative fire protection material, which overcomes the disadvantages of the prior art and enables flexible use in the visual range. Furthermore, the objective of the invention is to provide a method for producing a fire protection layer composite, which overcomes the disadvantages of the prior art and enables the fire protection layer to be laminated. In particular, the fire protection layer composite should make it possible to achieve effective fire protection in a compact design. Advantageously, the fire protection layer composite should also be suitable for not releasing any soot or and toxic fumes when exposed to high temperatures in order to prevent a health hazards to a user of the fire protection layer composite.

The objective is achieved by a fire protection layer composite and a method according to the respective independent claims. Advantageous aspects form the subject-matter of the respective subclaims.

The invention comprises a fire protection layer composite for use as a preventative fire protection material. The fire protection layer composite comprises or consists of at least one (transparent) plastic layer (optionally two such plastic layers) surrounding a transparent fire protection layer. The fire protection layer comprises an intumescent material. As a result, the visible surface of the plastic surface remains unchanged for the user and, in the event of fire, the fire protection layer has an intumescent and fire energy-absorbing effect.

The fire protection layer composite of at least one plastic film (optionally two plastic films) and a fire protection film, which can also be reinforced by fabric and fibers, or of a fire protection film laminated between two plastic films, or multiple structures of this arrangement (multi-layer composite), can in itself constitute an independent fire protection element (e.g., a fire protection curtain, a fire protection blind, a fire protection hood etc.). In other words, the fire protection layer composite and/or the multi-layer composite can consist of the aforementioned components. Alternatively, the fire protection layer composite and/or the multi-layer composite can comprise further components, i.e., be in the form of a composite with further components (e.g., a frame, a case and/or a wall) and thus form a part of a fire protection system.

According to one advantageous aspect, the plastic layer surrounds the fire protection layer completely or partially.

If the plastic layer surrounds the fire protection layer partially, preferably only on a first side of the fire protection layer, the fire protection layer composite can comprise a further layer, which is arranged on a second side of the fire protection layer opposite the first side. The further layer can have at least one property that the plastic layer of the fire protection layer composite also has. The plastic layer can be bonded and/or welded to the further layer (in particular in a liquid-tight manner) at least in some areas, preferably at one edge of the plastic layer. Preferably, the bonding is performed using a glue and/or an adhesive tape. The welding is preferably performed by ultrasonic welding and/or thermal welding of the plastic layer to the further layer. The further layer can comprise or consist of a material which is selected from the group consisting of plastic, glass, ceramic, metal, wood, and combinations thereof. In a preferred embodiment, the further plastic layer comprises a (preferably transparent) plastic material, which may be identical or different from the plastic material of the (first) plastic layer. However, it is also possible that the additional layer does not contain any (e.g., transparent) plastic material or does not consists of a (e.g., transparent) plastic material. It is conceivable for example, that the further layer is a wooden layer of a floor or a wooden layer of a ceiling, i.e., the fire protection layer composite is applied to a wooden floor or a wooden ceiling. In this case, the transparent plastic layer of the fire protection layer composite faces a user.

If the plastic layer completely surrounds the fire protection layer, the plastic layer can be bonded and/or welded to itself (in particular in a liquid-tight manner) at least in some areas, preferably at one edge of the plastic layer. Preferably, the bonding is performed by a glue and/or an adhesive tape. The welding is preferably performed by ultrasonic welding and/or thermal welding of the plastic layer to itself. Alternatively, if the plastic layer completely surrounds the fire protection layer, the fire protection layer is prevented from clouding when in use due to the contact with the surrounding air by forming alkali carbonates with the carbon dioxide from the air, which become visible as white crystals on the surface of the layer or are dissolved by contact with water and other cleaning agents. The change in the water content of the fire protection layer is also reduced or prevented by the enveloping polymer films.

It is particularly advantageous if the fire protection layer comprises a water-containing silicate layer, preferably an alkali silicate layer, particularly preferably a mixed alkali silicate layer of the alkali metals sodium and/or potassium and/or lithium. This results in good mechanical stability of the thick combined foam, which is formed in the event of fire and which is very resistant to flames.

According to a preferred aspect, the fire protection layer comprises aluminum dihydrogen phosphate. This means, among other things, that the plastic layer, which is highly flammable on its own, can also be used in compliance with the fire protection regulations and does not burn with heavy soot formation or droplet formation, but that the flames are largely extinguished and thus the flame formation and flammability are completely or largely prevented. A further advantage of aluminum dihydrogen phosphate (Al(H₂PO₄)₃) is that it has three phosphate groups per mole and therefore has a significantly higher flame retardant effect compared to a corresponding mole amount of aluminum phosphate (AlPO₄) for example. Apart from this, aluminum dihydrogen phosphate has the further advantage that it releases water in several temperature stages when heated, which in turn can delay heating of the fire protection layer composite due to its high specific heat capacity. Overall, the presence of aluminum dihydrogen phosphate in the fire protection layer results in significantly improved fire protection.

It is advantageous if the fire protection layer comprises foam-forming boron compounds. In this way, the intumescent effect can be improved.

The fire protection layer of the fire protection layer composite can have a thickness, in a direction perpendicular to the surface of the fire protection layer, in the range of 10 μm to 2 mm, preferably in the range of 50 μm to 1.5 mm, particularly preferably in the range of 100 μm to 1 mm, in particular in the range of 150 μm to 900 μm. A thickness in these ranges makes it possible to make the fire protection layer composite very compact, i.e., flat, without having a negative effect on the fire protection.

The fire protection layer can have a transmission of at least 80%, preferably at least 90%, particularly preferably at least 95%, for light of a wavelength in the range of 400 nm to 800 nm. The advantage of this embodiment is that objects on the other side of the fire protection layer composite can remain visible to a user of the fire protection layer composite. This allows rescue measures to be carried out more rapidly and safely.

According to one advantageous aspect, the plastic layer comprises a combustible, pyrolyzable or non-combustible plastic material. This means that flammable plastic materials from many areas of industry, transport or the home, where non-flammable materials are preferred, can be used. This means that many inexpensive commercial films come into question. As flammable base films, these include e.g., PET, PMMA, PC, PP, etc.

Non-flammable or poorly flammable films (e.g., ETFE, PVDF, PVdC) can also be used.

The plastic layer of the fire protection layer composite can have a thickness, in a direction perpendicular to the surface of the fire protection layer, in the range of 10 μm to 1 mm, preferably a thickness in the range of 20 μm to 500 μm, particularly preferably a thickness in the range of 40 μm to 200 μm, in particular a thickness in the range of 50 μm to 100 μm, optionally a thickness in the range of 60 μm to 80 μm. The smaller the thickness, the more flexible the fire protection layer composite. Furthermore, a small thickness enables a compact, i.e., flat, design of the fire protection layer composite. The small thickness has a further, surprising advantage: when exposed to heat, the thin plastic layer melts while the intumescent material of the fire protection layer simultaneously expands to form a foam. The resulting, expanded foam of the fire protection layer can completely absorb the melted, thin plastic layer and forms a glass that protects the plastic from oxygen and combustion. With the exclusion of oxygen and further exposure to heat, the plastic in the protective glass pyrolyzes to form carbon fibers, which give the expanded glass strong mechanical stability. This surprising effect is described in more detail below. Overall, this embodiment enables effective fire protection in a small installation space without releasing of soot and toxic fumes and without the risk of parts of the fire protection layer composite becoming detached. This can effectively prevent hazards to the health of a user of the fire protection layer composite.

The plastic layer can be transparent, preferably having a transmission, at least in some areas, of at least 80%, preferably at least 90%, particularly preferably at least 95%, for light with a wavelength in the range from 400 nm to 800 nm. The advantage of this embodiment is that objects on the other side of the fire protection layer composite can remain visible to a user of the fire protection layer composite. This allows rescue measures to be carried out more rapidly and safely.

Furthermore, the plastic layer can have a titanium oxide sol and/or zirconium oxide sol, at least in some areas, on one side facing the fire protection layer. The advantage here is that the adhesion of the plastic layer to the fire protection layer is improved, which increases the mechanical stability of the fire protection layer composite, as it prevents its delamination and thus its premature failure in the event of fire.

Advantageously, the material quantity ratio and/or the mass ratio of SiO₂/Na₂O of the fire protection layer is between 2 and 3, preferably between 1.5:1 and 6:1, particularly preferably between 3.3:1 and 4:1. This enables optimum workability of the fire protection layer in the fire protection layer composite.

According to one advantageous aspect, the material quantity ratio and/or the mass ratio of SiO₂/K₂O of the fire protection layer is between 5:1 and 1:1, preferably between 4:1 and 1.3:1, particularly preferably between 3.5:1 and 2:1. This means that the fire protection layer can be used in multiple ways.

It has proved to be advantageous if the material quantity ratio and/or the mass ratio of SiO₂/Li₂O of the fire protection layer is between 15:1 and 2:1, preferably between 7.5:1 and 2.5:1, particularly preferably between 6:1 and 3:1. This means that the materials can be used flexibly according to their use. Mixtures of these alkali metal water glasses are also possible as well as the production of water glasses or water glass mixtures of the alkali metals by mixing the corresponding alkali metal hydroxides with monodisperse and/or polydisperse silica sols.

It has proved to be advantageous if the fire protection layer has a water content in a range of 10-45%, preferably 20-30%. If a fire source is directed at the fire protection layer composite, the high heat capacity for the vaporization of the water in the fire protection layer first has to be applied. In the event of thermal load (fire), the described fire protection layer on an inorganic, water-containing basis reacts in such a way that the vaporization of the water contained and the simultaneous thermoplastic deformation of the layered material leads to intumescence or the formation of specifically coarse-grained or fine-grained foam. In this way, the volume of the material can easily increase by a factor of 10 to 20. Due to the high enthalpy of vaporization of the water contained in a relatively large amount, a considerable amount of energy is extracted from the system or the fire. The foam that is formed is thermally and mechanically stable even at high temperatures (as a carbon skeleton is formed from the plastic of the at least one plastic layer and the foam does not melt due to said carbon skeleton) and thermally insulating, so that neither the fire energy nor the flames are transmitted and the spread of fire can therefore be effectively prevented.

When the plastic is thermally exposed to at least one interface with the inorganic fire protection layer, the direct ignition of the plastic itself or of the liquid or gaseous pyrolysis products formed by its thermal exposure occurs in any case. When the burning plastic liquefies, there is a particular risk that dripping and burning plastic droplets may cause further fire propagation.

Surprising observation when both reactions occur: if both processes occur simultaneously however—if both materials are in direct contact—then it is surprising to see that a combined reaction of both materials (inorganic fire protection layer/plastic) occurs, which leads to a partial or even complete incombustibility of the combined foam that is formed. The reason for this lies in the time sequence of the two complementary reaction processes of the two materials described above and the resulting synergistic processes and material combinations that are formed. The parallel course of both reactions leads to the penetration of the inorganic foam and the melting plastic, so that the organic, carbon-containing and combustible material of the plastic is now enclosed by a non-combustible and gas-tight glass matrix and thus removed from the oxidizing atmosphere (air/oxygen). In the sequence of the reaction, this now leads to a carbonization of the organic matrix of the plastic and to the formation of a mechanically reinforcing carbon skeleton structure of the former plastic within the forming and enclosing glass structure. In this way, the mechanical and thermal properties of the thick foam structure that forms is significantly strengthened so that the melting of the foam can be effectively prevented even at high temperatures and higher fire loads and the protective effect can be increased. With a suitable combination of inorganic fire protection foam structure and use of meltable plastic material—or suitable material thicknesses of starting material in relation to one another—the incidence of fire can be prevented.

Another positive aspect is that, in the event of fire, the hybrid and large-volume foam structure made of cracked and carbonized plastic and silicate or phosphate matrix or coating that forms represents a thick and mechanically stable incombustible and heat-absorbing barrier against further flame attack and thus very effectively counteracts the further spread of fire. For example, a non-combustible foam can be created by melting the plastic and foaming the silicate layer, which protects the combustible polymer material from oxidation by oxygen and prevents it from burning by means of a glassy silicate layer. A further effect is the mechanical stabilization (increase in viscosity) of the silicate or phosphate foam by carbon particles which form therein through pyrolysis of the organic additives it contains (e.g., glycerol, amines, carboxylic acids, sugar compounds) in the event of fire. Last but not least, the water evaporating from the silicate layer can have such a strong cooling effect or the water vapor produced can make it difficult for oxygen to enter, that in an early phase of the fire the flames are extinguished or do not even form.

The fire protection layer of the fire protection layer composite can comprise 0 to 6 wt. %, preferably 0.1 to 5 wt. %, more preferably 0.2 to 4 wt. %, particularly preferably 0.3 to 3 wt. %, very preferably 0.4 to 2 wt. %, in particular 0.5 to 1 wt. %, glycerol, in relation to the total weight of the fire protection layer. Optionally, the fire protection layer does not contain glycerol. Glycerol in the fire protection layer can make the fire protection layer more flexible and accelerate its drying. However, a low content of glycerol or the absence of glycerol has the advantage that the fire protection layer and thus the fire protection layer composite can be provided more cost-effectively.

It is particularly advantageous if the fire protection layer comprises fibers, in particular glass fibers and/or metal fibers (e.g., stainless steel fibers) and/or metal alloy fibers and/or ceramic fibers. The fibers can be in the form of fabric. It is possible for the fire protection layer to comprise a ceramic fabric. Furthermore, it is possible that the fire protection layer comprises alkali-stable glass compositions (preferably as fibers, optionally in a fabric) and/or plastic compositions (preferably as fibers, optionally in a fabric). This makes it possible for a fire protection layer composite to be arranged in a freely suspended manner without melting and the associated dripping of the material or falling down of the material in the event of fire. The arrangement of the fibers is in a coarse mesh so that the fire protection layer composite is translucent. It is also possible that the plastic film itself comprises glass fiber fabric or metal wire fabric to prevent falling off.

According to a preferred aspect, the fibers have a fabric structure. A fabric is a material woven in a certain way and consisting of intersecting threads, such as e.g., a fine, coarse, strong, synthetic fabric. The fabric structure can be configured such that the fire protection layer is transparent in places where the fire protection layer has fibers of the fabric or has no fibers of the fabric. In the former case, the fabric itself can be transparent to visible light (i.e., light with a wavelength in the range of 400 nm to 800 nm). In the latter case, the fabric itself can be non-transparent to visible light, but the fabric structure can be configured for example such that the fire protection layer has fabric-free areas which are transparent to visible light. The fabric-free places can form a transparent grid in the fire protection layer. The transparent grid can enable the user to see the other side of the fire protection layer composite, allowing rescue operations to be carried out more rapidly and safely.

According to one advantageous aspect, the fire protection layer comprises at least one flexible film. This opens up a wide range of possible applications, for example also on surfaces made of glass, ceramic, plastic, metal and/or wood. For example, these surfaces can also be curved. Such surfaces can be used for example for furniture, containers etc. In this embodiment, the fire protection layer composite can be applied to the surface, in particular laminating the surface (e.g., a wooden surface).

Furthermore, the fire protection layer composite can be used to refine a web-like material by applying the fire protection layer composite to the web-like material (e.g., by laminating the web-like material with the fire protection layer composite). The web-like material can be selected from the group consisting of plastic film (e.g., comprising or consisting of another plastic than the at least one plastic layer of the fire protection layer composite), adhesive film, fabric web, wood decor, metal film, web-like foam, rubber film, elastomeric film, linoleum, glass fiber film, glass fabric film and combinations thereof.

It is advantageous if the fire protection layer composite is arranged between two glass panes (wherein the fire protection layer composite can consist of this arrangement). This has a positive effect on the UV resistance of the fire-resistant glass, if UV-absorbing types are used as polymer films. In classic fire-resistant glazing an additional plastic film such as an EVA or PVB-film is usually required for this purpose, as well as an additional pane of glass, which makes the entire structure considerably heavier. By arranging the fire protection layer composite between two glass panes, a significant reduction in weight can be achieved in combination with high UV resistance. A further advantage relates to the mechanical safety properties. A suitable polymer film (e.g., PVB or EVA) and a further pane of glass are required to produce “laminated safety glass” from fire-resistant glass. This further glass pane can be omitted, as the polymer safety film is already contained in the fire protection layer composite. The arrangement therefore leads to a significant reduction in weight in connection with the required mechanical safety properties of the composite safety glass. In a preferred embodiment, thus no further plastic layer comprising or consisting of ethylene vinyl acetate copolymer and/or polyvinyl butyral is arranged between each of the two glass panes and the fire protection layer, and particularly preferably no further plastic layer is arranged.

Alternatively however, a further plastic layer can be arranged between each of the two glass panes and the fire protection layer, wherein the further plastic layer particularly preferably comprises or consists of ethylene vinyl acetate copolymer and/or polyvinyl butyral. However, this alternative has the disadvantage that the fire protection layer composite is less compact and less light weight. One advantage can be higher mechanical stability of the fire protection layer composite.

If the fire protection layer consists of sodium silicate, water and polyalcohols (e.g., glycerol and/or sorbitol), visible hydrogen bubbles are formed when exposed to UV radiation. This makes the intermediate layer and thus e.g., also the fire protection-glass unit as a whole sensitive to ultraviolet light rays, since exposure to ultraviolet light causes clouding due to the development of fine and very fine bubbles in the fire protection layer. Surprisingly, the formation of hydrogen bubbles can be avoided if sodium hydroxide solution and adhesive sol (silica sol, i.e., SiO₂ particles) are used to produce the sodium silicate solution.

In a preferred embodiment, the fire protection layer therefore comprises SiO₂ particles. The SiO₂ particles preferably have an average diameter in the range of 5 to 50 nm, particularly preferably in the range of 10 to 15 nm. The average diameter of the SiO₂ particles refers in particular to a diameter determined by dynamic light scattering. It is advantageous, if the SiO₂ particles have a layer on their surface which comprises or consists of a silicate (e.g., sodium silicate, potassium silicate and/or lithium silicate). Such a layer can be produced for example, by treating the SiO₂ particles with an aqueous solution of an alkali hydroxide (e.g., aqueous solution of NaOH, KOH and/or LiOH).

For this purpose, 2 identical glass laminates of the structure 3 mm float glass/1 mm fire protection layer/3 mm float glass were produced with the fire protection layers of the exemplary embodiments 1 and 13. Both glass laminates were subjected to accelerated UV ageing in a sun tester and the development of bubbles and cloudiness over time was recorded.

The sample from exemplary embodiment 1 showed the known results of UV ageing. With increasing radiation time, many small and larger bubbles as well as extensive clouding were formed. Surprisingly, even after several days of UV ageing of the sample from exemplary embodiment 13 (fire protection layer contains sodium hydroxide-treated adhesive sol 30V12, i.e., comprises SiO₂ particles, with a diameter of 12 μm and a sodium silicate layer on the surface) no bubble formation or clouding was observed.

A Heraeus Suntest GPS was used with a xenon lamp, whose spectral emission largely corresponds to the spectral distribution of solar radiation in the UV range and in the visible light range. Radiation approx. 700 W/m² in the wavelength range 200-800 nm.

Radiation duration 5 days.

It is advantageous if the method is carried out using a sodium silicate solution comprising adhesive sol (silica sol) and sodium hydroxide solution. This prevents small visible bubbles of hydrogen from forming in the fire protection layer. The result is a fire protection film made from the raw materials adhesive sol and sodium hydroxide solution, which itself is already UV-stable.

According to one advantageous aspect, a multi-layer composite is formed which comprises or consists of at least two fire protection layer composites, wherein the fire protection layer composites are designed to be bonded to one another in a material-bonding manner. This allows the production of products with a much greater stability. For example, it can be used to produce viewing windows which are not made of glass, but are slightly flexible, yet mechanically more stable than a simple laminate. Any number of alternating layers of different materials can be bonded together. For example, the following structure is possible: plastic-fire protection layer-plastic-fire protection layer-wood-fire protection layer-fire protection layer-wood.

The invention further comprises a method for producing a fire protection layer composite, as explained above. The method comprises the steps:
providing at least one plastic layer and a flexible, transparent fire protection layer with an intumescent effect in the event of a fire,
laminating the fire protection layer between the plastic (of the at least one plastic layer) (optionally of a single plastic layer or two plastic layers) at a temperature of 50-150° C., preferably at a temperature of 100-120° C., particularly preferably at a temperature of 110° C.

This enables a fire protection layer to be laminated between two plastic layers.

Alternatively to laminating, it is also possible to bond the two plastic layers to the fire protection layer. Bonding with glass by means of pressure-sensitive adhesives and/or cross-linking adhesives and/or a cover film is also conceivable.

In the method according to the invention, the provision of the flexible, transparent fire protection layer can comprise or consist of the following steps:
i) applying an aqueous solution containing at least one fire protection material to the plastic layer; and
ii) drying the aqueous solution applied to the plastic layer.

The aqueous solution can have a viscosity in the range of 1000 mPa· to 30000 mPa·, wherein the viscosity refers to a viscosity which is determined by a viscometer VT550 of ThermoFischer using a SV-DIN measuring insert with a shear rate of 30 s⁻¹ bis 100 s⁻¹ at a temperature of 25° C.

In the method, a portion of the water can be removed from the solution before the solution is applied to the plastic layer, preferably by applying a vacuum. This measure can improve the viscosity and applicability of the solution on the plastic layer. Reducing the water content also has the advantage that the concentration of the intumescent material of the fire protection layer is increased and the total weight and total volume of the fire protection layer composite is reduced, which means that effective fire protection can be achieved in a more compact design. A further advantage of the prior removal of water and the simultaneous increase in viscosity is that this surprisingly reduces the drying time, which can generally be as long as 12-36 hours, to a range of a few hours down to 30 minutes. This indicates that the increase in viscosity also changes the structure of the coating material in such a way that it does not form an initially dried surface layer that acts as a diffusion batter for the water to be removed, which significantly delays the drying in volume in other conventional processes.

In the method, before the solution is applied to the plastic layer, the solution can also be degassed at a temperature of >25° C., preferably a temperature in the range of 60° C. to 80° C., and a pressure of <1013 mbar, preferably a pressure of 200 mbar, particularly preferably a pressure of 100 mbar. The degassing in these conditions can be carried out quickly and effectively. It is particularly preferable for the solution to be enriched, in particular saturated, with oxygen (e.g., pure oxygen). By way of these measures, the ageing stability of the fire protection film produced using the solution can be improved.

Apart from this, in the method, the drying of the solution applied to the plastic layer can be carried out by a method selected from the group consisting of convection drying, radiation drying, heating surface drying and combinations thereof. These methods have proven to be particularly fast drying methods.

In the following, the invention will be explained in more detail with reference to a drawing, without limiting it to the specific embodiment shown here.

In the drawing:

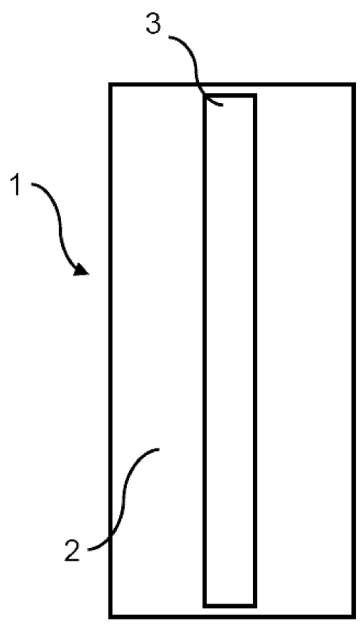

FIG. 1 shows a schematic representation of a fire protection layer composite according to the invention.

FIG. 1 shows a schematic representation of a fire protection layer composite 1 according to the invention. The fire protection layer composite 1 is used as a preventive fire protection material. The fire protection layer composite 1 comprises at least one plastic layer 2 surrounding a transparent fire protection layer 3. The fire protection layer 3 comprises an intumescent material. The plastic layer 2 thus retains its other advantageous properties, which would otherwise be altered by the flame-retardant additives. In addition, additives can still be added to the plastic layer 2 and the fire protection layer 3.

The fire protection layer composite 1 can be in the form of laminate for example. A laminate (from the Latin word lamina ‘layer’) is a material or a product that consists of two or more layers that are bonded/joined together. These layers can consist of the same or different materials. The production of a laminate is referred to as lamination. Other materials can also be used for sealing the edges of such laminate structures than for laminating itself. For example, the edges can be sealed by means of adhesive tape. Furthermore, a filler material can be applied in the edge region. The direct welding of the two plastic films at the edge (thermally or by ultrasound) is also possible.

By means of the fire protection laminates that have now been developed—a simple bilayer-laminate with film and fire protection agent—can be used to produce new and lighter fire protection materials by laminating or bonding this bilayer onto other substrates (e.g., glass or a web-like material).

For example, the glass/fire protection agent (fire protection layer)/plastic film structure has the advantage of a having a lighter structure compared to glass/fire protection layer/glass, and if the plastic film is applied to the outside, also provides protection from UV and break-ins.

Additional properties can be combined by selecting the film joined to the fire protection layer in combination with solar films, decorative films, films vaporized with a heat protective layer.

It is also advantageous, if the film is provided with an adhesive layer and a thin cover film that is easy to remove, so that the combination of film/fire protection layer/film/adhesive/(temporary) cover film (to be removed) can be bonded to various surfaces and make then fire-resistant. Alternatively, the film can be provided with a web-like material (optionally with an adhesive layer between the film and the web-like material), to produce a combination of film/fire protection layer/film/(optional adhesive/)web-like material. The web-like surface can comprise or consist of a textile fabric and/or leather. For example, this allows a cover for a seat in a car, an airplane and/or a ship to be equipped with the fire protection layer composite.

The following surfaces would be possible:
floors made of various materials (laminates, cork, PVC, carpets etc.)
building ceilings made of wood, wallpaper . . . .
styrofoam insulation for cold and heat insulation
container linings.

As shown in FIG. 1, the plastic layer 2 completely surrounds the fire protection layer 3. However, it is alternatively also possible for the fire protection layer 3 to be partially surrounded by the plastic layer 2. Such arrangements are suitable for example as paneling for wooden staircases in order to provide an escape route via the staircase in the event of fire. They can also be used to make strip curtains (transparent room dividers in industrial buildings, warehouses or shipbuilding). It is also possible to embed coarse-meshed fabrics, made of glass fibers, carbon, metal or metal alloy (e.g., steel, stainless steel, nickel-plated aluminum and/or titanium) in the fire protection layer 3, to prevent the strips from melting quickly and falling to the ground in the event of fire.

The fire protection layer 3 comprises a water-containing silicate layer, preferably an alkali silicate layer, particularly preferably a mixed alkali silicate layer of the alkali metals sodium and/or potassium and/or lithium. However, other materials for the fire protection layer 3 are also possible, such as for example aluminum dihydrogen phosphate with foaming additives, such as e.g., boron compounds, organic acids. A fire protection layer comprising aluminum dihydrogen phosphate can be used in the same way as a fire protection layer comprising a water-containing silicate layer, preferably an alkali silicate layer and thus represents an independent but equivalent alternative solution.

It is also conceivable that an alkali-silicate-based fire protection layer 3 could be laminated directly between two panes of glass to produce fire protective glass. This also allows curved fire protective glass to be produced which are otherwise only be produced with gel filling and fixed dimensions. Thus fire protective glass with large dimensions can be produced, e.g., 3.2 m×6 m (band dimensions) or even 3.2 m×9 m or 3.2 m×12 m and also composites with chemically (Berlin glass) or thermally toughened glass (TVVG, toughened borofloat from Schott, ESG), as this glass is not compatible with the usual drying process in the production of e.g., Pyrostop—the glass would lose its toughening by prolonged tempering.

The water-containing silicate film foams up in the event of fire and is not flammable itself. For example, vehicle windows can be produced in this way which are installed in electric vehicles for example. This prevents the flames from spreading to the vehicle's surroundings, such as other vehicles or a car park or garage, in the event of a fire inside the vehicle. Furthermore, fire protection laminates can also be used to protect the floor, the various plastic parts, the fabric or leather upholstery, the headlining, the boot lining, etc. The floor protection of the electric vehicle is particularly important, as this is where the vehicle's main battery is located over a large area and, in the event of a battery fire, a fire-retardant device gives people in the vehicle the crucial time they need to get out and save their lives. In the case of a battery, the fire protection layer composite can also serve to prevent an initial ignition of the battery (e.g., from its first primary cell) from spreading the fire. This can be achieved by coating the battery (or at least one cell of the battery) with the fire protection layer composite. The fire protection layer composite can also be used to protect individual—now replaceable—partial battery elements, entire battery sections, battery housings and battery heaters. For this purpose, the fire protection layer composite can encase a partial battery element, an entire battery section, a battery housing and/or a battery heater.

The plastic layer 2 comprises a flammable plastic material. The flammability of a plastic material is strongly influenced by its chemical structure, fillers, additives (e.g., plasticizers) and shaping. Some plastics burn very easily, others are flame-retardant in accordance with DIN 4102 B 1 or do not continue to burn once the source of ignition has been removed.

Flame-retardant finishes are often achieved by incorporating halogen, phosphorus, boron or nitrogen compounds, aluminum oxide hydrate and antimony trioxide.

The material quantity ratio and/or the mass ratio of SiO₂/Na₂O of the fire protection layer 3 is between 2 and 3 preferably between 1.5:1 and 6:1, particularly preferably between 3.3:1 and 4.0:1.

The material quantity ratio and/or the mass ratio of SiO₂/K₂O of the fire protection layer 3 is between 5:1 and 1:1, preferably between 4:1 and 1.3:1, particularly preferably between 3.5:1 and 2:1.

The material quantity ratio and/or the mass ratio of SiO₂/Li₂O of the fire protection layer 3 is between 15:1 and 2:1, preferably between 7.5:1 and 2.5:1, particularly preferably between 6:1 and 3:1.

The fire protection layer 3 has a water content of 10-45%, preferably of 20-30%. In addition, the fire protection layer 3 optionally comprises fibers, in particular glass fibers and/or stainless steel fibers and/or ceramic fibers and/or ceramic fabric and/or alkali-stabile glass compositions and/or plastic compositions. The fibers are introduced into the inorganic intumescent fire protection layer 3 in the form of wide-meshed fabrics. As result, the transparency of the fire protection layer 3 is maintained and transparent packaging can be produced, for example. The fibers have a fabric structure.

The fire protection layer 3 comprises a flexible film. For example, the film is a water-containing, intumescent alkali-silicate film, which is arranged between plastic films that are flammable. The water-containing, intumescent alkali silicate film has a strong flame-retardant effect and ideally even prevents ignition. In combination with the plastic framework, the foaming silicate forms a barrier against flames to protect flammable materials behind it. Preventive fire protection with room enclosure and radiation inhibition can thus be achieved.

A method for producing a fire protection layer composite 1 comprises the steps:
providing a plastic layer 2 and a flexible, transparent fire protection layer 3 with an intumescent effect in the event of fire,
laminating and/or bonding the fire protection layer 3 between the plastic at a temperature from 90-150° C., preferably at a temperature from 100-120° C., particularly preferably at a temperature of 110° C.

For example, an alkali silicate film with a film thickness of 0.1-2 mm, such as e.g., sodium silicate film, can be laminated between two PET films, polyester films, or PVC films.

The production of such a silicate film can be performed in different ways, e.g., by extrusion through a slot die, calendering or drying a viscous solution on a carrier film. In the latter case, a carrier film could be selected which can then remain in the end product. For a composite of a plastic and a fire protection film laminating would be superfluous. Only if the fire protection film is to be surrounded on both sides by plastic films, at least one plastic would have to be laminated onto the fire protection film.

A particular feature of production by drying compared to the usual drying of aqueous alkali silicate solutions is that the drying process is accelerated and the application method simplified by working with concentrated or higher viscosity solutions. In particular, the application for desired higher wet film thicknesses in this case does not require the application of an additional edge barrier, which may need to be predried, as otherwise in the prior art.

The invention is explained in more detail in the following with reference to exemplary embodiments, without wishing to limit these to the specific embodiments shown here:

### Exemplary Embodiment 1

For the preparation of the coating solution NS, the following are mixed together:
268.8 g sodium water glass Betol 39 T (Woellner)
11.2 g sodium hydroxide
5.6 g glycerol
1.4 g sorbitol.

Water is removed from the mixture in a rotary evaporator, leaving 216.9 g of the original mass 287 g. The product is a colorless, transparent, viscous solution. The water content is generally between 46% and 49%.

A commercial PET-film, e.g., Hostaphan GN 125.0 4600 A (130 μm thick, Mitsubishi Polyester) is used as the carrier and cover film. The viscous solution described above is applied to the polyester film using a doctor blade (coating bar) (doctor blade gap 1 mm).

After storing the coated film in air at room temperature for 20 h, the water content was only approx. 30% to 35%. In order to achieve the desired final water content of 24% to 28% the film was tempered at approx. 80° C. in air for approx. 1.5 h to 2 h.

The bonding was performed using the vacuum bonding process in an incapcell vacuum laminator from sm innotech in Bocholt at approx. 110° C. within approx. 5 min.

The edges were sealed by taping with a 15 mm wide PET adhesive tape with an alkali-resistant acrylate adhesive layer.

### Exemplary Embodiment 2

As in exemplary embodiment 1 with the following differences: PET-films (e.g., Hostaphan RN100, 100 μm thick, Mitsubishi Polymers), which have been pretreated using the Pyrosil process (Innovent e.V./SURA Instruments GmbH), are used as the carrier and cover film. This increases the wettability and improves the adhesion.

Immediately after doctoring, the carrier film with layer is transferred into a heatable drying chamber (volume: 15 I) and dried in an oxygen flow of 0.6 I/min for a total of 2 h at 80° C.

### Exemplary Embodiment 3

As in exemplary embodiment 1 with the following differences:

Instead of 1.4 g sorbitol, 1.4 g sodium aminopropyl siliconate are used.

In order to achieve the desired final water content of 25%, tempering was carried out at approx. 100° C. in air for approx. 6 h.

### Exemplary Embodiment 4

As in exemplary embodiment 2 with the following differences: The drying is performed in a vacuum as follows:
immediately after doctoring, the carrier film with layer is transferred to a vacuum drying oven and dried there at 350 mbar and 75° C. for a total of 3 h to 4 h.

The semi-laminate is bonded to the cover film using an autoclave process. Firstly, a so-called “pre-bond” is created between the semi-laminate and the cover film using a roller press and a bonding agent (50% glycerol solution in water). A permanent bond is then created between the films in an autoclave by heat (approx. 100° C.) and pressure (approx. 12 bar).

To seal the edges, the silicate layer was removed up to 4 mm from the edge and replaced with a transparent alkali-resistant hot adhesive (melt adhesive).

### Exemplary Embodiment 5

To prepare the coating solution AP, firstly 121.12 g aluminum hydroxide paste Alugel type A 671 (Chemipharm) are dissolved in 125 g phosphoric acid 85%. Then 3.28 g tartaric acid and 0.76 g glycolic acid are dissolved. Water is removed from the mixture in a rotary evaporator, leaving 149 g of the original mass 250.16 g. The product is a transparent, viscous solution.

A PET film (e.g., Hostaphan RN100, 100 μm thick, Mitsubishi Polymers) was used as the carrier and cover film, which was coated with a transparent adhesion-promoting layer a few micrometers thick as follows: 1 g glycerol, 0.5 g lupamine 9095 (BASF), 2 g poval solution (12% poval 4-88 in water, Kuraray) are dissolved in 18 g water. This solution is applied thinly to the polyester film with a spiral doctor blade and dried at 100° C. for a few minutes.

Using a doctor blade (coating bar), the viscous coating solution AP described above is applied to the polyester film (doctor blade gap 1 mm) and dried (at room temperature or at a raised of up to 100° C.).

Drying for 6 hours in a vacuum drying oven at 250 mbar and 95° C. reduces the water content from an initial 26% to 7%.

The cover film is laminated using a heatable calendar with a feed speed of 7 cm/min at a roll temperature of 120° C.

To seal the edges, the phosphate layer was removed up to 4 mm from the edge and the PET films were ultrasonically welded together.

### Exemplary Embodiment 6

As in exemplary embodiment 5 with the following differences: PET films (e.g., Hostaphan RN100, 100 μm thick, Mitsubishi Polymers) which have been pretreated using the Pyrosil process (Innovent e.V./SURA Instruments GmbH), are used as the carrier and cover film. This increased the wettability and improved the adhesion.

To seal the edge, the silicate layer was removed 4 mm from the edge and replaced with a transparent acid-resistant elastic adhesive.

### Exemplary Embodiment 7

As in exemplary embodiment 1 with the following differences: For the preparation of the coating solution NS, the following are mixed together:
99 g sodium water glass Betol 39 T (Woellner)
1 g potassium water glass K28 T (Woellner)
4 g sodium hydroxide.

Water is removed from the mixture in a rotary evaporator so that 79 g of the original mass of 102.5 g remain. The product is a colorless, transparent, viscous solution. The water content is 50%.

To seal the edges, the silicate layer was removed up to 4 mm from the edge and the PET films were thermally welded together.

### Exemplary Embodiment 8

As in exemplary embodiment 1 with the following differences:
immediately after doctoring, the carrier film with layer is transferred to a heatable drying chamber (volume 15 liters) and dried in an oxygen flow of 0.6 I/min for a total of 2 h at 80° C.

A tape press with a process temperature of 105° C., a pressing pressure of 0.5 N/cm² and a contact time of 6 min was used to laminate the cover film.

### Exemplary Embodiment 9

As in exemplary embodiment 5 with the following differences: To prepare the coating solution AP, firstly 20.79 g aluminum hydroxide paste Alugel type A 671 (Chemipharm) is dissolved in 17.48 g phosphoric acid 85%. Then a solution of 0.18 g sodium hydroxide is added to 11 g water and finally 1.03 g borax. Water is removed from the mixture in a rotary evaporator, leaving 27.6 g of the original mass 47 g. The product is a transparent, viscous solution.

Drying for 6 hours in a vacuum drying oven at 250 mbar and 95° C. reduces the water content from an initial 26% to 11%.

### Exemplary Embodiment 10

For the preparation of the coating solution NS, the following are mixed together:
268.8 g sodium water glass Betol 39 T (Woellner)
11.2 g sodium hydroxide
0.34 g hydroxyethyl amino-di(methylenephosphonic acid), HEMPA (Cublen R50)

Water is removed from the mixture in the rotary evaporator so that the water content is only 46 to 49%.

After storage of the coated film in air at room temperature for 20 hours, the water content was only approx. 35%.

The bonding was performed using the vacuum bonding process in an incapcell vacuum laminator from sm innotech in Bocholt at approx. 110° C. within approx. 5 min.

The edges were sealed by taping with a 15 mm wide PET adhesive tape with an alkali-resistant acrylate adhesive layer.

### Exemplary Embodiment 11

As in exemplary embodiment 1 with the following differences: For the preparation of the coating solution NS, the following are mixed together:
100 g sodium water glass Betol 39 T (Woellner)
4 g sodium hydroxide
2 g glycerol
0.5 g sorbitol
0.5 g borax.

Water is removed from the mixture in a rotary evaporator, leaving 81.8 g of the original mass 103.5 g. The product is a colorless, transparent, viscous solution. The water content was 49%.

For edge sealing, the silicate layer was removed 4 mm from the edge and replaced with a transparent alkali-resistant elastic adhesive.

### Exemplary Embodiment 12

As in exemplary embodiment 8 with the following differences: Polypropylene Films SP6OLB from Profol are Used as Carrier and Cover Films with the following adhesion-promoting coating: a titanium oxide-zirconium oxide sol is applied to the films with a spiral doctor blade, produced by hydrolysis and condensation of titanium and zirconium alcoholates in isopropanol with diluted nitric acid. The metal oxide content of the sol is 0.3% for example. This layer can be dried in air at room temperature.

### Exemplary Embodiment 13

As in exemplary embodiment 1 with the following differences:

For the preparation of the coating solution US, the following are mixed together:
100 g adhesive sol 30V12 (silica sol)
160 g water
16.86 g sodium hydroxide
and heated at reflux while stirring until a clear solution is obtained. Then
2.36 g glycerol and
0.6 g sorbitol.
are added with stirring.

Water is removed from the mixture in a rotary evaporator, resulting in a water content of 43.2%. The product is a colorless, transparent, viscous solution.

The following applies to all exemplary embodiments:
the formulations can be combined with the described drying, laminating and edge sealing processes in almost any way. The parameters have to be adjusted to each individual case.

The table shows an overview of the exemplary embodiments:

| | Formulation | Film | Drying | Composite | Edge |
|---|---|---|---|---|---|
| 1 | Sodium water glass | Hostaphan GN | Air, 22-80° C., | Vacuum | Adhesive |
| | Glycerol | 125.0 4600 A | 1.5-2 h | | tape |
| | Sorbitol | (Polyester) | | | |
| 2 | Sodium water glass | RN100 | Oxygen, | Vacuum | Adhesive |
| | Glycerol | (polyester), | 80° C., 2 h | | tape |
| | Sorbitol | coated by | | | |
| | | “Pyrosil | | | |
| | | process” | | | |
| 3 | Sodium water glass | Hostaphan GN | Air, 100° C. | Vacuum | Adhesive |
| | Glycerol | 125.0 4600 A | 6 h | | tape |
| | Sodium | (Polyester) | | | |
| | aminopropyl | | | | |
| | siliconate | | | | |
| 4 | Sodium water glass | RN100 | Vacuum, | Autoclave | Melt |
| | Glycerol | (polyester), | 75° C., 4 h | | adhesive |
| | Sorbitol | coated by | | | |
| | | “Pyrosil | | | |
| | | process” | | | |
| 5 | Aluminum | RN100 with | Vacuum, | Calender | Ultrasonic |
| | hydroxide | layer of | 95° C., 6 h | | welding |
| | Phosphoric acid | Lupamin/Poval/ | | | |
| | Tartaric acid | Glycerol | | | |
| | Glycolic acid | solution | | | |
| 6 | Aluminum | RN100 | Vacuum, | Calender | Adhesive |
| | hydroxide | (polyester), | 95° C., 6 h | | |
| | Phosphoric acid | coated by | | | |
| | Tartaric acid | “Pyrosil | | | |
| | Glycolic acid | process” | | | |
| 7 | Sodium water glass | Hostaphan GN | Vacuum, | Calender | Thermal |
| | Potassium water | 125.0 4600 A | 95° C., 6 h | | welding |
| | glass | (Polyester) | | | |
| 8 | Sodium water glass | Hostaphan GN | Oxygen, | Tape press | Adhesive |
| | Glycerol | 125.0 4600 A | 80° C., 2 h | | tape |
| | Sorbitol | (Polyester) | | | |
| 9 | Aluminum | RN100 with | Vacuum, | Calender | Ultrasonic |
| | hydroxide paste | layer of | 95° C., 6 h | | welding |
| | Phosphoric acid | Lupamin/Poval/ | | | |
| | Sodium hydroxide | Glycerol | | | |
| | Borax | solution | | | |
| 10 | Sodium water glass | Hostaphan GN | Air, 22° C., | Vacuum | Adhesive |
| | Hydroxyethylamino- | 125.0 4600 A | 20 h | | tape |
| | di(methylene- | (Polyester) | | | |
| | phosphonic acid) | | | | |
| 11 | Sodium water glass | Hostaphan GN | Vac 80° C. | Vacuum | Adhesive |
| | Glycerol | 125.0 4600 A | 2 h | | |
| | Sorbitol | (Polyester) | | | |
| | Borax | | | | |
| 12 | Sodium water glass | Profol SP6OLB | Oxygen, | Tape press | Adhesive |
| | Glycerol | (Polypropylene), | 80° C. 2 h | | tape |
| | Sorbitol | coated with | | | |
| | | titanium oxide/ | | | |
| | | Zirconium oxide | | | |
| 13 | Adhesive sol 30V12 | Hostaphan GN | 80° C. 2 h | Vacuum | Adhesive |
| | Sodium hydroxide | 125.0 4600 A | | | tape |
| | Glycerol | (Polyester) | | | |
| | Sorbitol | | | | |

1-31. (canceled)

32. A fire protection layer composite comprising at least one plastic layer and a transparent fire protection layer, wherein the at least one plastic layer surrounds the transparent fire protection layer completely or partially, wherein the at least one fire protection layer comprises an intumescent material.

33. The fire protection layer composite according to claim 32, wherein the at least one plastic layer partially surrounds the fire protection layer.

34. The fire protection layer composite according to claim 33, wherein the at least one plastic layer partially surrounds only on a first side of the fire protection layer, and wherein the fire protection layer composite comprises a further layer, which is arranged on a second side of the fire protection layer opposite to the first side, wherein the plastic layer is bonded and/or welded to the further layer at least in some areas.

35. The fire protection layer composite according to claim 34, wherein the plastic layer is bonded and/or welded to the further layer at an edge of the plastic layer.

36. The fire protection layer composite according to claim 35, wherein
i) the bonding is by a glue and/or an adhesive tape; and/or
ii) the welding is by ultrasonic welding and/or thermal welding of the plastic layer.

37. The fire protection layer composite according to claim 32, wherein the plastic layer completely surrounds the fire protection layer, wherein the plastic layer is bonded and/or welded to itself at least in some areas.

38. The fire protection layer composite according to claim 37, wherein
i) the bonding is by a glue and/or an adhesive tape; and/or
ii) the welding is by ultrasonic welding and/or thermal welding of the plastic layer.

39. The fire protection layer composite according to claim 32, wherein the fire protection layer comprises a water-containing silicate layer.

40. The fire protection layer composite according to claim 32, wherein the fire protection layer comprises aluminum dihydrogen phosphate.

41. The fire protection layer composite according to claim 32, wherein the fire protection layer comprises one or more foam-forming boron compounds.

42. The fire protection layer composite according to claim 32, wherein the fire protection layer has a thickness, in a direction perpendicular to the surface of the fire protection layer, in the range of 10 μm to 2 mm.

43. The fire protection layer composite according to claim 32, wherein the fire protection layer has a transmission of at least 80%, at least in some areas, for light of a wavelength in the range of 400 nm to 800 nm.

44. The fire protection layer composite according to claim 32, wherein the plastic layer comprises at least one combustible, pyrolyzable or non-combustible plastic material.

45. The fire protection layer composite according to claim 44, wherein the plastic material is selected from the group consisting of PET, PMMA, PC, PP, PVC, ETFE, PVDF, PVdC, and combinations thereof.

46. The fire protection layer composite according to claim 32, wherein the plastic layer has a thickness, in a direction perpendicular to the surface of the fire protection layer, in the range of 10 μm to 1 mm.

47. The fire protection layer composite according to claim 46, wherein the plastic layer has a transmission of at least 80%, at least in some areas, for light of a wavelength in the range of 400 nm to 800 nm.

48. The fire protection layer composite according to claim 32, wherein the plastic layer has a titanium oxide sol and/or zirconium oxide sol, at least in some areas, on a side facing the fire protection layer.

49. The fire protection layer composite according to claim 39, wherein the material quantity ratio and/or the mass ratio of SiO₂/Na₂O of the fire protection layer is between 2 and 3.

50. The fire protection layer composite according to claim 39, wherein the material quantity ratio and/or the mass ratio of SiO₂/K₂O of the fire protection layer is between 5:1 and 1:1.

51. The fire protection layer composite according to claim 39, wherein the material quantity ratio and/or the mass ratio of SiO₂/Li₂O of the fire protection layer is between 15:1 and 2:1.

52. The fire protection layer composite according to claim 32, wherein the fire protection layer has a water content in a range of 10-45 wt %.

53. The fire protection layer composite according to claim 32, wherein the fire protection layer comprises 0 to 6 wt. % glycerol, in relation to the total weight of the fire protection layer, wherein the fire protection layer optionally does not contain any glycerol.

54. The fire protection layer composite according to claim 32, wherein the fire protection layer comprises fibers.

55. The fire protection layer composite according to claim 50, wherein the fibers have a fabric structure.

56. The fire protection layer composite according to claim 32, wherein the fire protection layer comprises at least one flexible film.

57. The fire protection layer composite according to claim 32, wherein the fire protection layer composite is arranged between two glass panes and optionally consists of this arrangement, wherein, between each of the two glass panes and the fire protection layer,
i) no further plastic layer which comprises ethylene-vinyl acetate copolymer and/or polyvinyl butyral is arranged; or
ii) a further plastic layer is arranged, wherein the further plastic layer comprises ethylene-vinyl acetate copolymer and/or polyvinyl butyral.

58. The fire protection layer composite according to claim 32, wherein the fire protection layer comprises SiO₂ particles, wherein the SiO₂ particles have an average diameter in the range of 5 to 50 nm, wherein the average diameter refers to a diameter determined by dynamic light scattering.

59. A multilayer composite comprising at least two fire protection layer composites according to claim 32.

60. A method for producing a fire protection layer composite, comprising:
providing at least one plastic layer and a flexible, transparent fire protection layer which has an intumescent effect in the event of fire, and
laminating and/or bonding the fire protection layer between the at least one plastic layer at a temperature of 50-150° C.

61. The method for producing a fire protection layer composite according to claim 60, comprising applying a sodium silicate solution comprising adhesive sol and sodium hydroxide solution.

62. The method according to claim 60, wherein the providing of flexible, transparent fire protection layer includes:
i) applying an aqueous solution containing at least one fire protection material to the plastic layer; and
ii) drying the aqueous solution applied to the plastic layer.

63. The method according to claim 62, wherein the aqueous solution has a viscosity in the range of 1000 mPa·s to 30000 mPa·s, as determined by a viscometer VT550 from ThermoFischer via a measuring insert SV-DIN measurement with a shear rate of 30 s⁻¹ to 100 s⁻¹ at a temperature of 25° C.

64. The method according to claim 62, wherein prior to applying the solution to the plastic layer, a portion of the water is removed from the solution.

65. The method according to claim 58, wherein prior to applying the solution to the plastic layer, the solution is degassed at a temperature of >25° C.

66. The method according to claim 58, wherein prior to applying the solution to the plastic layer, it is enriched with oxygen.

67. The method according to claim 62, wherein the drying of the solution applied to the plastic layer is carried out by a method selected from the group consisting of convection drying, radiation drying, heating surface drying, and combinations thereof.
